(19) United States
(12) Patent Application Publication
(10) Pub. No.: US 2026/0079437 A1
(43) Pub. Date: Mar. 19, 2026

(54) SHEET DISCHARGE AND ACCOMMODATION DEVICE AND IMAGE FORMING APPARATUS

(71) Applicant: FUJIFILM Business Innovation Corp., Tokyo (JP)

(72) Inventors: Yuki Kohno, Kanagawa (JP); Yuya Chonabayashi, Kanagawa (JP); Yasunobu Goto, Kanagawa (JP); Satoshi Watanabe, Kanagawa (JP); Suguru Goto, Kanagawa (JP); Yoshinori Kodakari, Kanagawa (JP); Yasuhisa Fukuda, Kanagawa (JP); Yuki Kawazoe, Kanagawa (JP)

(73) Assignee: FUJIFILM Business Innovation Corp., Tokyo (JP)

(21) Appl. No.: 19/062,846

(22) Filed: Feb. 25, 2025

(30) Foreign Application Priority Data
Sep. 13, 2024 (JP) 2024-158738

(51) Int. Cl. G03G 15/00

(52) U.S. Cl. CPC G03G 15/6573; G03G 2215/00421

(57) ABSTRACT

A sheet discharge and accommodation device includes: a main body having a discharge port; an accommodation portion having an accommodation surface on which a sheet discharged from the discharge port is accommodated and a side wall surface that extends from one end of the accommodation surface to a lower end of the discharge port; a discharge roll that pinches the sheet between plural roll bodies disposed on plural shafts and discharges the sheet from the discharge port to the accommodation portion; a moving unit that is provided with the discharge roll and reciprocates in a width direction intersecting a discharge direction of the sheet; and a wall surface portion that is provided in the moving unit, is present at least in a space from an upper end of the side wall surface to a shaft that is closer to the upper end among the plural shafts, and is present on a downstream side of the side wall surface in the discharge direction.

### CROSS-REFERENCE TO RELATED APPLICATIONS

This application is based on and claims priority under 35 USC 119 from Japanese Patent Application No. 2024-158738 filed Sep. 13, 2024.

### BACKGROUND

### (i) Technical Field

The present invention relates to a sheet discharge and accommodation device and an image forming apparatus.

### (ii) Related Art

JP2007-197198A (claim 1 and FIGS. 2 and 4) describes a sheet medium alignment device including a discharge unit, a stacking unit, a moving unit, an alignment member, and a retraction unit.

The discharge unit is a unit that discharges a transported sheet medium. The stacking unit is a unit that stacks the sheet medium discharged by the discharge unit. The moving unit is a unit that moves the stacking unit by a predetermined amount in a shift direction orthogonal to a discharge direction of the sheet medium. The alignment member is a member that aligns the sheet medium on the stacking unit by comes into contact with the sheet medium such that the sheet medium is interposed between sheet-medium-side end portions that are parallel to the discharge direction of the sheet medium.

The retraction unit is a unit that rotates the alignment member about a rotation shaft to retract the alignment member in a direction perpendicular to the discharge direction of the sheet medium during a shift operation of sorting the discharged sheet medium.

JP5156691B (claim 1 and FIGS. 2 to 5) discloses a sheet discharge device including a sheet discharge tray, a shifter, and a sheet pressing member.

The sheet discharge tray is configured such that a sheet subjected to a predetermined process is discharged to the sheet discharge tray. The shifter is supported to be reciprocatable in a width direction orthogonal to a sheet transport direction above the sheet discharge tray. The sheet pressing member is a member that is swingably supported by the shifter and that comes into contact with the sheet discharged to the sheet discharge tray to suppress curling of both ends of the sheet in the width direction.

In addition, JP5156691B (claim 1 and FIGS. 2 to 5) discloses that the sheet pressing member includes a sheet support portion and sheet pressing sheets.

The sheet support portion is a portion that is swingably supported by the shifter through an engagement portion disposed in a central portion and that extends from the engagement portion to both sides in the width direction. The sheet pressing sheets are two sheet pressing sheets that are attached to the sheet support portion and that are disposed on both sides of the engagement portion, respectively.

Further, JP5156691B (claim 1 and FIGS. 2 to 5) discloses that each of the sheet pressing sheets has a cut-out portion formed in a central portion of an end portion, which comes into contact with the sheet discharged to the sheet discharge tray, in the width direction.

JP2015-113200A (claim 1 and FIG. 1) discloses a sheet stacking apparatus including a sheet stacking portion, a sheet discharge portion, and a floating restriction member.

The sheet stacking portion is a portion in which a sheet is stacked on a stacking surface. The sheet discharge portion is a portion that discharges the sheet to the sheet stacking portion. The floating restriction member is a member that is provided above the stacking surface and that restricts the floating of a leading end portion of the sheet from the stacking surface with a surface facing the stacking surface.

In addition, JP2015-113200A (claim 1 and FIG. 1) discloses that, in the floating restriction member, a gap between the stacking surface and the facing surface on the upstream side in a sheet transport direction is larger than a gap between the stacking surface and the facing surface on the downstream side in the sheet transport direction.

### SUMMARY

Aspects of non-limiting embodiments of the present disclosure relate to a sheet discharge and accommodation device that can prevent a rear end of a sheet discharged from a sheet discharge port to an accommodation surface of an accommodation portion by a discharge roll capable of reciprocating in a width direction during the discharge of the sheet from entering a gap present between the discharge roll and a side wall surface of the accommodation portion and an image forming apparatus using the sheet discharge and accommodation device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a sheet discharge and accommodation device including: a main body having a discharge port; an accommodation portion having an accommodation surface on which a sheet discharged from the discharge port is accommodated and a side wall surface that extends from one end of the accommodation surface to a lower end of the discharge port; a discharge roll that pinches the sheet between a plurality of roll bodies disposed on a plurality of shafts and discharges the sheet from the discharge port to the accommodation portion; a moving unit that is provided with the discharge roll and reciprocates in a width direction intersecting a discharge direction of the sheet; and a wall surface portion that is provided in the moving unit, is present at least in a space from an upper end of the side wall surface to a shaft that is closer to the upper end among the plurality of shafts, and is present on a downstream side of the side wall surface in the discharge direction.

### BRIEF DESCRIPTION OF THE DRAWINGS

Exemplary embodiment(s) of the present invention will be described in detail based on the following figures, wherein:

FIG. 1 is a schematic view showing an image forming apparatus including a sheet discharge and accommodation device according to Exemplary Embodiment 1;

FIG. 2 is a schematic perspective view showing the sheet discharge and accommodation device according to Exemplary Embodiment 1;

FIG. 3 is a schematic partial cross-sectional view showing the sheet discharge and accommodation device taken along a line III-III of FIG. 2;

FIG. 4 is a schematic top view showing a portion of the sheet discharge and accommodation device shown in FIG. 3;

FIG. 5 is a schematic partial cross-sectional view showing the sheet discharge and accommodation device taken along a line V-V of FIG. 3;

FIG. 6 is a schematic enlarged view showing a portion of the sheet discharge and accommodation device shown in FIG. 5;

FIG. 7 is a schematic top view showing a portion of the sheet discharge and accommodation device shown in FIG. 6;

FIG. 8 is an enlarged view showing a configuration of a wall surface portion and a recessed portion which are a portion of the sheet discharge and accommodation device shown in FIG. 5;

FIG. 9A is a schematic view showing a portion of the sheet discharge and accommodation device shown in FIG. 3, and FIG. 9B is a schematic top view showing the portion shown in FIG. 9A;

FIG. 10 is a schematic partial cross-sectional view showing a state of an operation or the like of the sheet discharge and accommodation device;

FIG. 11 is a schematic top view showing the state of the operation or the like of the sheet discharge and accommodation device;

FIG. 12 is a schematic view showing a portion of a sheet discharge and accommodation device according to a modification example;

FIG. 13 is a schematic perspective view showing a sheet discharge and accommodation device according to a comparative example;

FIG. 14 is a schematic partial cross-sectional view showing a state of an operation or the like of the sheet discharge and accommodation device according to the comparative example; and

FIG. 15A is a schematic view showing an example of wrong assembly of a side wall surface of an accommodation portion, and FIG. 15B is a schematic top view showing an example of FIG. 15A.

### DETAILED DESCRIPTION

Hereinafter, exemplary embodiments of the present invention will be described.

### Exemplary Embodiment 1

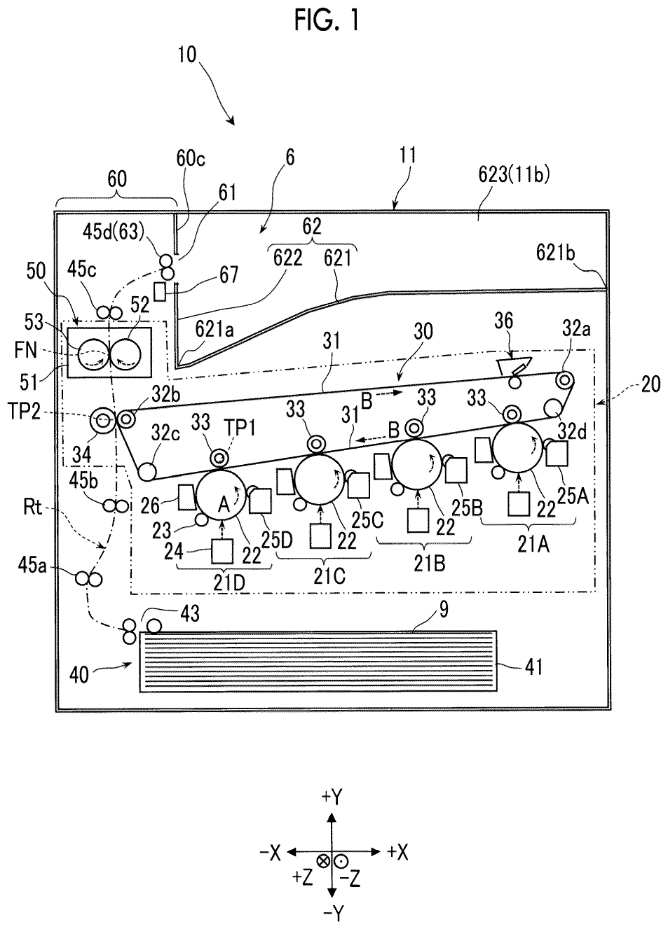

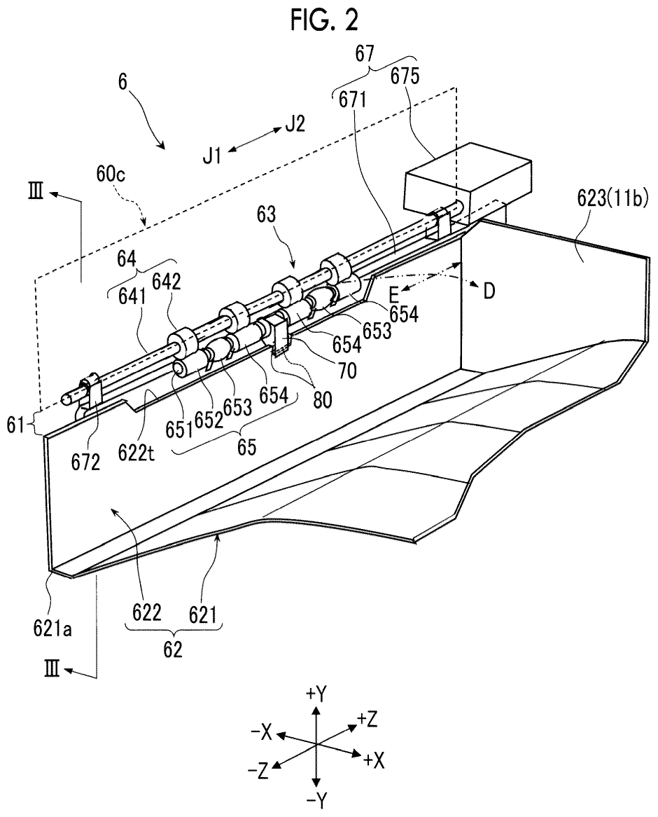

FIG. 1 shows an image forming apparatus 10 including a sheet discharge and accommodation device 6 according to Exemplary Embodiment 1. FIG. 2 shows the sheet discharge and accommodation device 6 according to Exemplary Embodiment 1.

In the present specification and the drawings, substantially identical components are denoted by identical reference numerals. Further, a repeated description of the identical components will be omitted in the present specification.

An arrow +X shown in FIG. 1 and the like indicates a right direction in a case where the image forming apparatus 10 and the like are viewed from a front side, and an arrow −X indicates a left direction in that case. In addition, an arrow +Y indicates an upward direction of the image forming apparatus 10 and the like, and an arrow −Y indicates a downward direction of the image forming apparatus 10 and the like. Further, letter +Z indicates a depth direction in a case where the image forming apparatus 10 and the like are viewed from the front side, and letter −Z indicates a front direction in that case.

Further, a symbol with “×” inside “○” in FIG. 1 and the like indicates a direction from a front side to a back side of the plane of paper of the drawing. A symbol with “⋅” inside “○” in FIG. 1 and the like indicates a direction from the back side to the front side of the plane of paper of the drawing.

### Image Forming Apparatus

The image forming apparatus 10 is an apparatus that forms a predetermined image on a sheet 9.

As shown in FIG. 1, the image forming apparatus 10 includes an image forming device 20, a sheet supply device 40, and the like disposed in an internal space of a housing 11. In addition, the image forming apparatus 10 includes the sheet discharge and accommodation device 6 disposed over the inside and outside of the housing 11.

Among these components, the housing 11 is a box-shaped structure that has a predetermined appearance shape and an internal space.

The housing 11 is configured by, for example, a frame, a plate, an exterior material, or the like.

The image forming device 20 according to Exemplary Embodiment 1 is configured as a device that adopts an image forming method such as an electrophotographic method.

The image forming device 20 includes four image forming units 21A, 21B, 21C, and 21D, an intermediate transfer unit 30, and a fixing unit 50.

The image forming units 21A, 21B, 21C, and 21D are units that form toner images of unfixed images consisting of developers of predetermined colors (A, B, C, and D), respectively. Examples of the predetermined colors (A, B, C, and D) include colors such as yellow, magenta, cyan, and black.

Each of the image forming units 21A, 21B, 21C, and 21D has a photoreceptor drum 22 that is rotationally driven in a direction indicated by an arrow A.

In addition, a charging device 23, an exposure device 24, a developing device 25, a drum cleaning device 26, and the like are similarly disposed around each of the photoreceptor drums 22.

The charging device 23 is a device that charges an image forming surface of an outer peripheral surface of the photoreceptor drum 22 to a predetermined surface potential. The exposure device 24 is a device that irradiates the charged image forming surface of the photoreceptor drum 22 with light to form an electrostatic latent image. The light to be emitted is generated corresponding to image information input from the outside of the image forming apparatus 10. The developing device 25 is a device that develops the electrostatic latent image on the photoreceptor drum 22 with a developer (toner) of a predetermined color to form a toner image.

In FIG. 1, reference numerals of the charging device 23, the exposure device 24, and the drum cleaning device 26 are representatively displayed only for the image forming unit 21D. In addition, the developing device 25 are displayed as developing devices 25A, 25B, 25C, and 25D corresponding to the fact that the colors (A, B, C, and D) of the developers to be used are different.

The intermediate transfer unit 30 is a unit that relays each toner image formed by the image forming units 21A, 21B, 21C, and 21D of the image forming device 20 and transfers the toner images to the sheet 9.

The intermediate transfer unit 30 includes an intermediate transfer belt 31, a primary transfer device 33, a secondary transfer device 34, a belt cleaning device 36, and the like.

The intermediate transfer belt 31 is an endless belt that can mainly hold the toner image on an outer peripheral surface of the belt with an electrostatic force and transporting the toner image.

The intermediate transfer belt 31 is rotated while passing through each of the photoreceptor drums 22 of the image forming units 21A, 21B, 21C, and 21D. In addition, the intermediate transfer belt 31 is wound around a predetermined number of support rolls 32a, 32b, 32c, and 32d and is rotated in a direction indicated by an arrow B. The support roll 32a is configured as a drive roll, and the support roll 32b is configured as a secondary transfer back roll.

The primary transfer device 33 is a device that primarily transfers each toner image formed on each photoreceptor drum 22 onto the outer peripheral surface of the intermediate transfer belt 31.

The secondary transfer device 34 is a device that secondarily transfers the toner image primarily transferred to the outer peripheral surface of the intermediate transfer belt 31 to one side of the sheet 9.

Letters TP1 in FIG. 1 indicate a primary transfer position where the primary transfer device 33 faces each photoreceptor drum 22 with the intermediate transfer belt 31 interposed therebetween. In addition, letters TP2 indicate a secondary transfer position where the secondary transfer device 34 faces the support roll 32b with the intermediate transfer belt 31 interposed therebetween.

The sheet supply device 40 is a device that accommodates a predetermined sheet 9 and supplies the sheet 9 to the image forming device 20.

The sheet supply device 40 includes an accommodation body 41 that accommodates the sheet 9, a feeding device 43 that feeds the sheets 9 one by one from the accommodation body 41, and the like. The sheet supply device 40 may include a plurality of sets of the accommodation bodies 41 and the feeding devices 43.

The sheet 9 is a recording medium which is transported inside the housing 11 and to which the toner image and the like can be transferred by the image forming device 20. A sheet-like recording medium cut to a predetermined size is mainly used as the sheet 9.

The fixing unit 50 is a unit that fixes the toner images formed on the sheet 9 by the image forming device 20 to the sheet 9.

The fixing unit 50 is configured by disposing a heating rotating body 52, a pressurizing rotating body 53, and the like in a fixing housing 51. The heating rotating body 52 and the pressurizing rotating body 53 are roll-shaped or belt-shaped rotating bodies. In addition, the heating rotating body 52 and the pressurizing rotating body 53 come into contact with each other under pressure and are rotated in a direction indicated by a dashed arrow.

In the fixing unit 50, a contact portion between the heating rotating body 52 and the pressurizing rotating body 53 is a fixing nip FN through which the sheet 9 passes for a fixing process.

A sheet transport path Rt represented by a one-dot chain line in FIG. 1 is provided inside the housing 11.

The sheet transport path Rt has a transport path from the sheet supply device 40 to a discharge port 61 through the secondary transfer position TP2 and the fixing unit 50.

In addition, the sheet transport path Rt is configured by a predetermined number of pairs of transport rolls 45a, 45b, 45c, and 45d and a transport guide member (not shown). The pair of transport rolls 45d correspond to a discharge roll 63 which will be described below.

The sheet discharge and accommodation device 6 is a device that discharges the sheet 9 from the discharge port 61 of the housing 11 and accommodates the sheet 9.

The sheet discharge and accommodation device 6 according to Exemplary Embodiment is disposed at a position on an upper end side of the housing 11.

In addition, the sheet discharge and accommodation device 6 constitutes a portion (a portion on the upper end side) of the housing 11.

The sheet discharge and accommodation device 6 will be described in detail below.

### Image Forming Operation

The formation of the image by the image forming apparatus 10 is performed as follows.

Here, a case where toner images are formed by all of the image forming units 21A, 21B, 21C, and 21D of the image forming device 20 will be described.

In the image forming apparatus 10, in a case where a controller (not shown) receives an instruction to perform an image forming operation, the image forming device 20, the sheet supply device 40, and the like are started.

In this case, in the image forming device 20, each of the photoreceptor drums 22 of the image forming units 21A, 21B, 21C, and 21D starts to rotate in the direction represented by the arrow A. Further, a charging operation, an exposure operation, a developing operation, a transfer operation, and a cleaning operation are executed on the rotating photoreceptor drum 22.

In addition, in this case, in the image forming device 20, the intermediate transfer belt 31 of the intermediate transfer unit 30 starts to rotate in the direction represented by the arrow B. In the intermediate transfer unit 30, a primary transfer operation, a secondary transfer operation, and a cleaning operation are executed.

Further, in this case, in the sheet supply device 40 and the sheet transport path Rt, a sheet feeding operation is executed in synchronization with the timing of the secondary transfer operation.

Therefore, in the image forming device 20, the toner image of the color corresponding to the photoreceptor drum 22 is formed, is primarily transferred to the intermediate transfer belt 31 and is then transported to the secondary transfer position TP2.

Meanwhile, in the image forming device 20, a predetermined sheet 9 is sent from the sheet supply device 40 and is supplied to the secondary transfer position TP2 through the sheet transport path Rt.

Then, in the image forming device 20, the toner image is secondarily transferred from the intermediate transfer belt 31 to the sheet 9 at the secondary transfer position TP2.

In addition, in a case where the image forming device 20 receives the instruction to perform the image forming operation, the heating rotating body 52 and the pressurizing rotating body 53 start to rotate in the fixing unit 50. Further, in the fixing unit 50, the fixing operation is executed after a temperature state in which the fixing operation can be executed is maintained.

Therefore, in the image forming device 20, the sheet 9 to which the toner image has been secondarily transferred is introduced to the fixing nip FN of the fixing unit 50 and passes through the fixing nip FN.

In this case, the toner on the sheet 9 is heated and melted under pressure and is fixed to the sheet 9 in a case where the toner passes through the fixing nip FN.

Finally, in the image forming apparatus 10, the sheet 9 after the fixing is transported from the fixing unit 50 to the sheet discharge port 61 through the sheet transport path Rt.

In this case, the sheet 9 after the fixing is discharged from the discharge port 61 by the discharge roll 63 of the sheet discharge and accommodation device 6 and is accommodated in an accommodation portion 62 which will be described below. The sheet 9 is discharged in a discharge direction D toward the accommodation portion 62 by the discharge roll 63.

The image forming operation of forming an image composed of predetermined colors (A, B, C, and D) on one side of one sheet 9 is ended by the above-described series of operations.

### Sheet Discharge and Accommodation Device

As shown in FIGS. 1 and 2, the sheet discharge and accommodation device 6 includes a main body 60 having the discharge port 61 for the sheet, the accommodation portion 62, the discharge roll 63, a moving unit 67, and the like.

The main body 60 in Exemplary Embodiment 1 is a structure that constitutes a portion of the housing 11 of the image forming apparatus 10. The main body 60 may be a dedicated structure that is independent of the housing 11.

The discharge port 61 is an opening through which the sheet 9 passes to be discharged to the outside.

The discharge port 61 is provided in a predetermined portion on the side where the accommodation portion 62 is disposed in the main body 60.

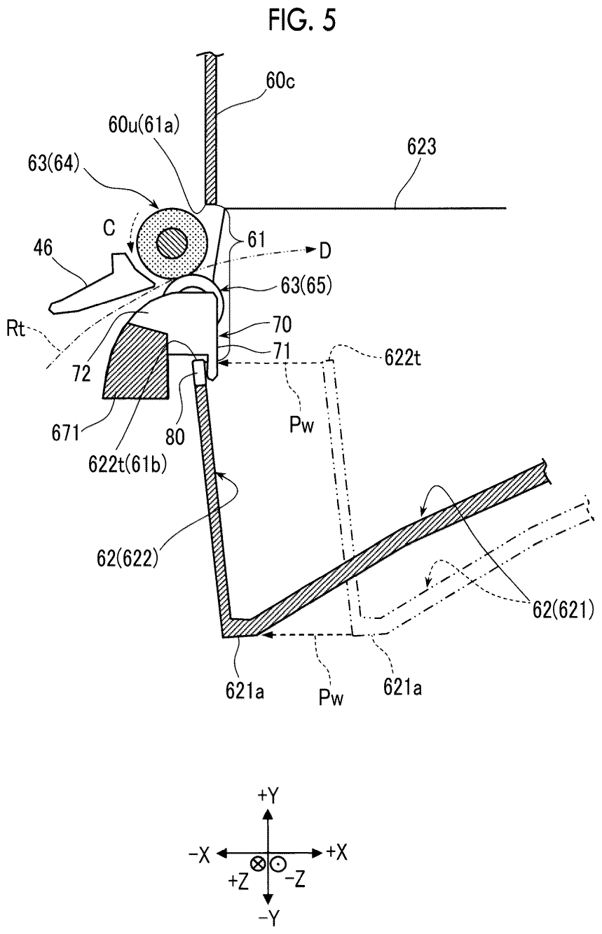

The discharge port 61 in Exemplary Embodiment 1 is formed as an opening surrounded by a lower side 60u of a side surface portion 60c of the main body 60, upper ends 622t and 622k of a side wall surface 622 of the accommodation portion 62, and the like. The lower side 60u of the side surface portion 60c is an upper end 61a of the discharge port 61 (see FIG. 5 and the like).

The accommodation portion 62 has at least an accommodation surface 621 and the side wall surface 622.

The accommodation surface 621 and the side wall surface 622 are configured by plate-shaped members.

The accommodation surface 621 is a portion in which the sheet 9 discharged from the discharge port 61 is accommodated.

The accommodation surface 621 in Exemplary Embodiment 1 is formed by a curved surface portion and a horizontal surface portion. The curved surface portion is a portion consisting of a surface that extends obliquely upward in a curved manner from a lower end of the side wall surface 622 with a predetermined width. The horizontal surface portion is a portion consisting of a surface that extends substantially horizontally from an upper end of the curved surface portion.

The side wall surface 622 is a portion that extends from one end 621a of the accommodation surface 621 to a lower end 61b of the discharge port 61. The one end 621a of the accommodation surface 621 is an end portion closer to the discharge port 61. The other end 621b of the accommodation surface 621 is an end portion farther from the discharge port 61.

The side wall surface 622 in Exemplary Embodiment 1 is formed as an inclined surface that slopes in a direction away from the accommodation surface 621 toward the upper end.

In addition, the upper end of the side wall surface 622 includes the central upper end portion 622t and the edge upper end portion 622k. The central upper end portion 622t is an upper end of a portion of the side wall surface 622 that is closer to the center in a width direction E. The edge upper end portion 622k is an upper end of a portion that is slightly higher than the central upper end portion 622t in the right and left end portions of the central upper end portion 622t in the width direction E.

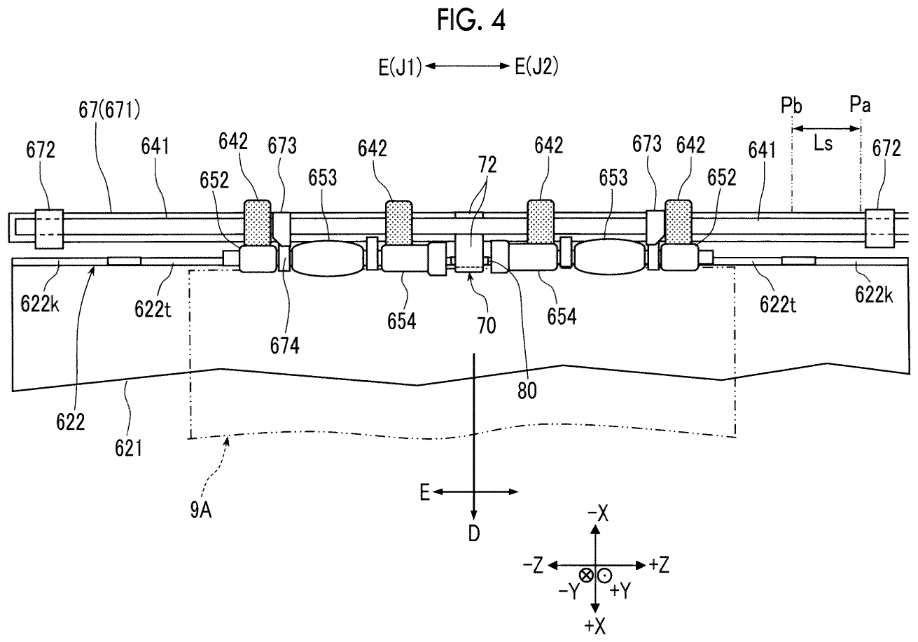

The width direction E is a direction that substantially orthogonally intersects the discharge direction D of the discharge roll 63 as shown in FIG. 2, FIG. 4, and the like.

In addition, the accommodation portion 62 in Exemplary Embodiment 1 has a rear wall surface 623.

The rear wall surface 623 is a portion consisting of a surface that rises from each back-side end portion of the accommodation surface 621 and the side wall surface 622 in a substantially vertical direction.

The rear wall surface 623 is configured as a portion of the accommodation portion 62. However, the rear wall surface 623 may be configured as a portion 11b of the housing 11.

The discharge roll 63 is a pair of rolls that discharge the sheet 9 from the discharge port 61 to the accommodation portion 62 while pinching the sheet 9.

As shown in FIG. 2 and the like, the discharge roll 63 in Exemplary Embodiment 1 is a roll obtained by combining a drive roll 64 and a driven roll 65.

The drive roll 64 is a roll that is attached in a state in which a plurality of roll bodies 642 are fixed to a shaft 641.

The shaft 641 is a drive shaft that receives power from a rotation drive device (not shown) and is rotated. The roll body 642 is a disk-shaped rotating body having a predetermined width. Four roll bodies 642 are used. The four roll bodies 642 are disposed on the shaft 641 at predetermined intervals.

The driven roll 65 is a roll in which a plurality of roll bodies 652, 653, and 654 are rotatably attached to a shaft 651.

The shaft 651 is a rotary shaft that is rotatably attached to a bearing 674.

Two sets of the roll bodies 652, 653, and 654 are used, and a total of six roll bodies are disposed on the shaft 651 at predetermined intervals.

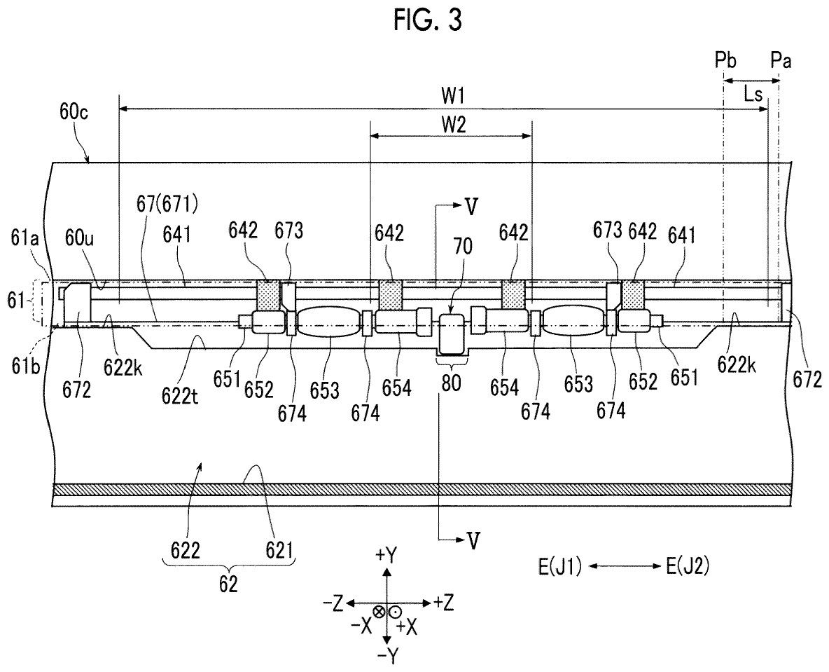

The roll body 652 is a cylindrical rotating body having a predetermined width. In addition, the roll body 653 is a rotating body having a crown (spindle) shape in which a central portion in an axial direction is raised. Further, the roll body 654 is a cylindrical rotating body in which a large-diameter portion is provided in one end portion as shown in FIG. 3.

In addition, the driven roll 65 is configured by two shafts obtained by dividing the shaft 651 in the width direction E. The two shafts 651 are disposed such that a predetermined gap is formed therebetween in a central portion in the width direction E.

Further, in the driven roll 65, the two roll bodies 652 and 654 are brought into contact with the roll body 642 of the drive roll 64.

One roll body 653 is disposed between two roll bodies 652 and 654 in a freely rotatable state.

The drive roll 64 and the driven roll 65 of the discharge roll 63 are mounted on a moving body 671 (which will described below) in the moving unit 67.

As shown in FIG. 3, FIG. 4, and the like, the drive roll 64 is mounted in a state in which the shaft 641 is supported by bearings 672 and 673 provided in the moving body 671.

The driven roll 65 is mounted in a state in which the shaft 651 is supported by the bearings 672 and 673 provided in the moving body 671.

The moving unit 67 is a portion that has the discharge roll 63 mounted thereon and reciprocates in the width direction E intersecting the discharge direction D of the sheet.

The moving unit 67 operates in a case where a mode in which the sheets 9 having different image contents and types are stacked and accommodated on the accommodation surface 621 of the accommodation portion 62 while deviating in the width direction E is selected.

The mode in this case is referred to as, for example, an offset accommodation mode. The selection of the offset accommodation mode is performed manually or automatically.

The moving unit 67 includes the moving body 671 and a movement drive device 675.

The moving body 671 is a structure that reciprocates in the main body 60 along a longitudinal direction (which is also the width direction E) of the discharge port 61.

The moving body 671 in Exemplary Embodiment 1 is configured by an elongated plate-shaped member having a predetermined thickness and length. The moving body 671 is supported to be movable along the width direction E inside the main body 60 (housing 11).

In addition, the bearings 672 and 673 and the like that support the discharge roll 63 are provided in an upper end portion of the moving body 671.

The bearings 672 and 673 may be provided integrally with the moving body 671 or may be separate from the moving body 671 and attached to the moving body 671.

The movement drive device 675 is a device that drives the moving body 671 to reciprocate by a predetermined distance Ls along the width direction E.

The movement drive device 675 in Exemplary Embodiment 1 is configured as a device to which a rack and pinion method is applied. Therefore, the movement drive device 675 reciprocates the moving body 671 in directions represented by arrows J1 and J2.

A drive mechanism, a drive method, and the like for reciprocating the moving body 671 in the movement drive device 675 are not limited to the above and may be other mechanisms and methods.

In a case where the offset accommodation mode is not selected, the movement drive device 675 continues to stop the moving body 671 at a present standby position Pa (see FIG. 3, FIG. 4, and the like).

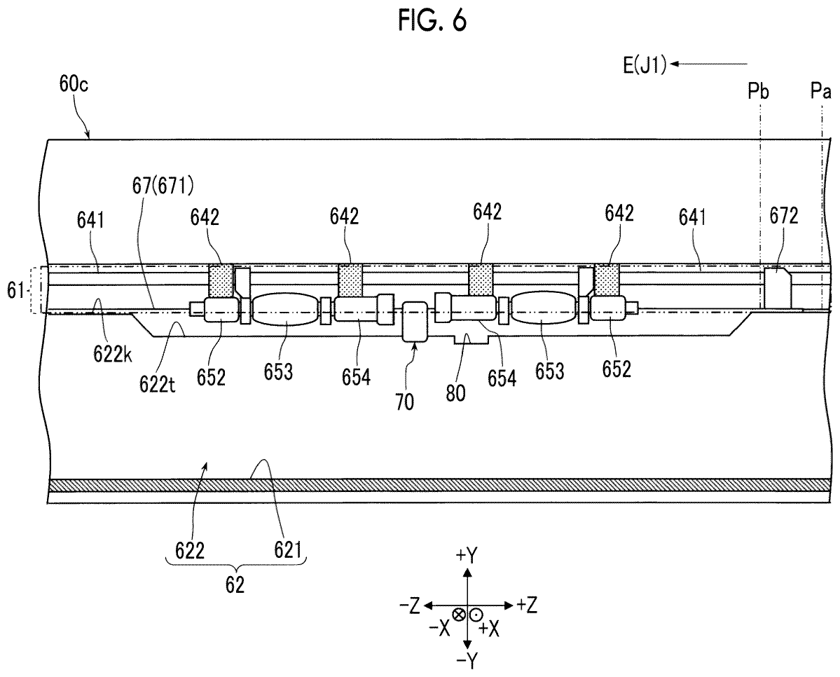

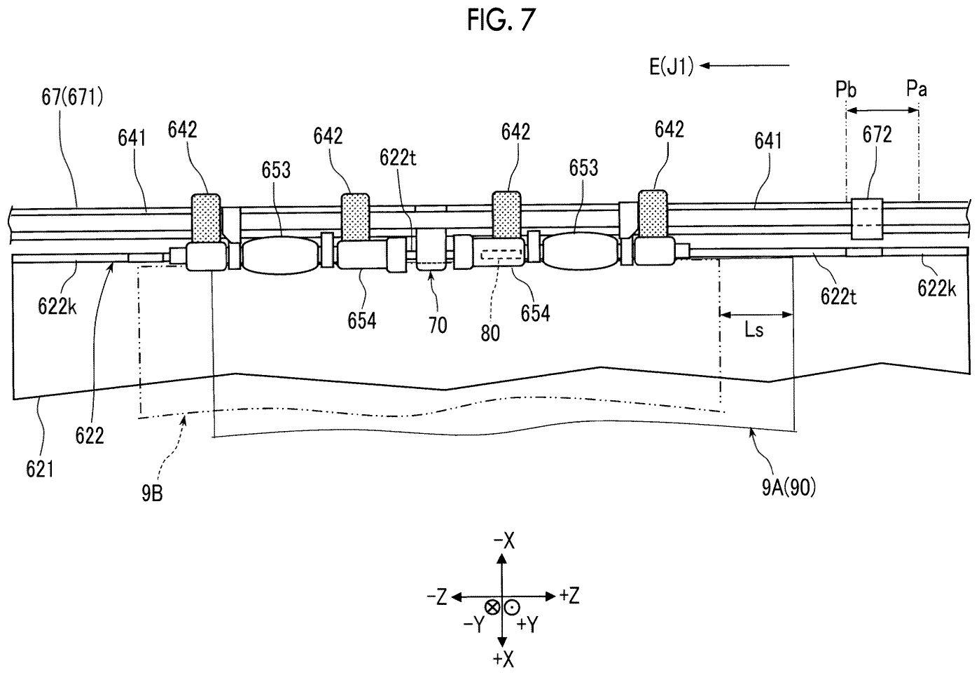

The movement drive device 675 operates as follows in a case where the offset accommodation mode is selected. That is, in a case where the time to execute the offset accommodation comes, the movement drive device 675 moves the moving body 671 from the standby position Pa to a present movement destination position Pb and stops the moving body 671 (see FIG. 6, FIG. 7, and the like).

In addition, in a case where the movement drive device 675 continuously performs the offset accommodation, the movement drive device 675 alternately repeats the movement of the moving body 671 to the movement destination position Pb and the standby position Pa.

Further, in a case where an odd number of offset accommodations have been ended, the movement drive device 675 finally returns the moving body 671 to the standby position Pa and stops the moving body 671.

Here, it is assumed that the direction in which the moving body 671 is moved from the standby position Pa to the movement destination position Pb is a first movement direction J1. In addition, it is assumed that the direction in which the moving body 671 is moved from the movement destination position Pb to the standby position Pa is a second movement direction J2.

In Exemplary Embodiment 1, the first movement direction J1 is set as a movement direction from the back side to the front side (a direction represented by the arrow −Z). The second movement direction J2 is set as a movement direction from the front side to the back side (a direction represented by the arrow +Z).

### Operation of Discharging Sheet and Operation of Accommodating Sheet

In a case where the sheet 9 is transported to the discharge roll 63 through the sheet transport path Rt, the sheet discharge and accommodation device 6 executes a discharge operation and an accommodation operation as follows.

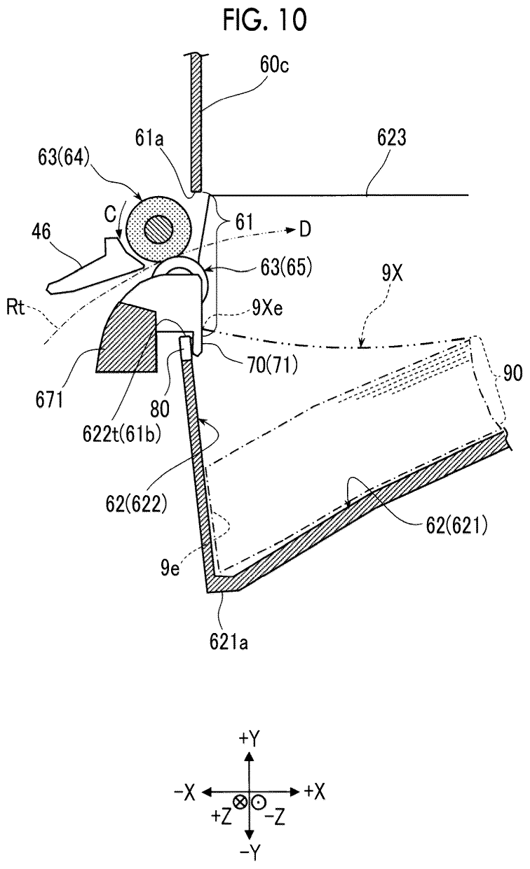

In this case, in the sheet discharge and accommodation device 6, as shown in FIG. 10, the drive roll 64 of the discharge roll 63 is rotationally driven in a direction represented by an arrow C. In addition, with the rotational driving of the drive roll 64, the driven roll 65 of the discharge roll 63 is rotationally driven.

Then, the sheet 9 is transported while being pinched between the roll body 642 of the drive roll 64 and the roll bodies 652 and 654 of the driven roll 65 in the discharge roll 63.

Then, the sheet 9 transported by the discharge roll 63 is discharged toward the accommodation portion 62 through the discharge port 61 and then falls onto the accommodation surface 621 to be accommodated on the accommodation surface 621. A position of a rear end 9e of the sheet 9 which is an upstream side in the discharge direction D in this case is held while the rear end 9e is in contact with the side wall surface 622 of the accommodation portion 62 as represented by a two-dot chain line in FIG. 4.

In a case where a plurality of sheets 9 are stacked and accommodated on the accommodation surface 621 of the accommodation portion 62, the plurality of sheets 9 form a sheet bundle 90 as represented by a two-dot chain line in FIG. 10.

In addition, the sheet discharge and accommodation device 6 operates as follows in a case where the offset accommodation mode is selected in the image forming apparatus 10.

In this case, in the sheet discharge and accommodation device 6, first, the discharge operation and the accommodation operation are performed in a state shown in FIG. 3, FIG. 4, and the like.

That is, in this case, the operations are performed in a state in which the moving body 671 of the moving unit 67 is stopped at the standby position Pa.

Then, a sheet 9A as an object to be first accommodated in this case is discharged by the discharge roll 63 that is stopped at a position corresponding to the standby position Pa of the moving body 671. Then, the sheet 9A is accommodated on the accommodation surface 621 of the accommodation portion 62 in a state shown in FIG. 4.

In this case, the sheet 9A is accommodated in a state in which the rear end 9e thereof is in contact with the side wall surface 622 of the accommodation portion 62.

Then, in a case where the time to execute the offset accommodation comes, the discharge operation and the accommodation operation are performed in a state shown in FIGS. 6 and 7 in the sheet discharge and accommodation device 6.

That is, in this case, the operations are performed in a state in which the moving body 671 of the moving unit 67 is moved from the standby position Pa to the movement destination position Pb.

Then, a sheet 9B as an object to be subjected to the offset accommodation in this case is discharged by the discharge roll 63 that is stopped at a position corresponding to the movement destination position Pb of the moving body 671. Then, the sheet 9B is accommodated in a state in which the sheet 9B is stacked on the sheet 9A previously accommodated on the accommodation surface 621 of the accommodation portion 62 as shown in FIG. 7.

In this case, the sheet 9B is accommodated in a state in which the rear end 9e thereof is in contact with the side wall surface 622 of the accommodation portion 62 similarly to the sheet 9A.

In addition, in this case, the sheet 9B is accommodated in a state in which the sheet 9B is shifted from the sheet 9A previously accommodated on the accommodation surface 621 to the front side by the predetermined distance Ls. That is, the sheet 9B is accommodated in a state in which the sheet 9B is offset with respect to the sheet 9A.

### Further Configuration of Sheet Discharge and Accommodation Device

Then, as shown in FIGS. 2 to 9 and the like, in the sheet discharge and accommodation device 6, a wall surface portion 70 is provided in the moving body 671 of the moving unit 67.

In addition, as shown in FIGS. 2 to 9 and the like, in the sheet discharge and accommodation device 6, a recessed portion 80 is also provided at the upper end of the side wall surface 622 of the accommodation portion 62.

### Wall Surface Portion

The wall surface portion 70 is a portion that is present at least in a space from the upper end of the side wall surface 622 of the accommodation portion 62 to the shaft 651, which is closer to the upper end, of the shafts 641 and 651 of the discharge roll 63. The upper end of the side wall surface 622 in Exemplary Embodiment 1 includes the central upper end portion 622t and the edge upper end portion 622k. In the present example, the central upper end portion 622t corresponds to the upper end of the side wall surface 622.

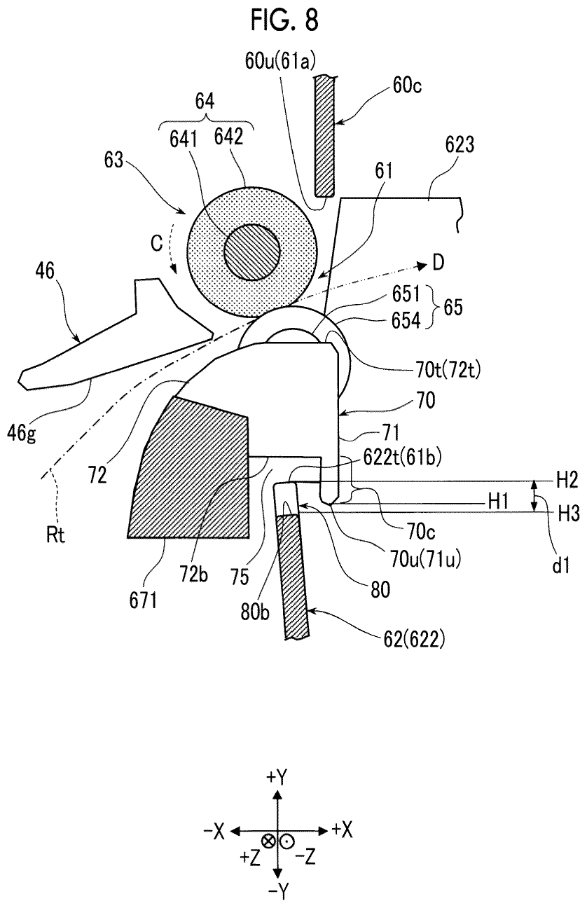

In addition, the wall surface portion 70 is also a portion that is present on the downstream side of the side wall surface 622 of the accommodation portion 62 in the discharge direction D of the sheet 9. As shown in FIGS. 5 and 8, in practice, in the wall surface portion 70, a wall surface 71 facing the accommodation portion 62 may be present at least on the downstream side in the discharge direction D.

As shown in FIGS. 5 and 8, the wall surface portion 70 is provided in an end portion of a main body portion 72.

The main body portion 72 is a portion having a shape that extends from the upper portion of the moving body 671 of the moving unit 67 to the discharge roll 63.

In addition, the main body portion 72 has a curved surface in a portion opposite to the wall surface portion 70. The curved surface of the main body portion 72 is a surface that is curved from the upper portion of the moving body 671 to approach the roll body 654 of the driven roll 65 of the discharge roll 63. The curved surface of the main body portion 72 constitutes a portion (a lower transport guide member) of the sheet transport path Rt leading to the discharge roll 63.

Further, in the main body portion 72, a lower surface portion 72b protrudes toward the accommodation portion 62 through the upper side of the central upper end portion 622t which is the upper end of the side wall surface 622 of the accommodation portion 62 (see FIG. 8).

Reference numeral 46 in FIG. 8 and the like indicates one of the transport guide members of the sheet transport path Rt. The transport guide member 46 is disposed to face the upper portion of the moving body 671 and the curved surface of the main body portion 72 with a gap therebetween. In addition, a guide portion 46g is formed at a lower end of the transport guide member 46.

Further, the wall surface portion 70 is provided to enter a gap between adjacent roll bodies among the roll bodies 642, 652, 653, and 654 in the discharge roll 63.

As shown in FIG. 3, the wall surface portion 70 in Exemplary Embodiment 1 is provided in a gap present in a range, in which the sheet 9 having a minimum width W2 as the width W during discharge passes, among the gaps between adjacent roll bodies among the plurality of roll bodies in the discharge roll 63.

Specifically, the gap present in the range in which the sheet 9 with the minimum width W2 passes is a gap between adjacent roll bodies 654 and 654. Therefore, the wall surface portion 70 is disposed in the gap between the adjacent roll bodies 654 and 654.

In addition, the sheet 9 is transported through the sheet transport path Rt in a state in which a center position of the width W of the sheet 9 is aligned with a center position of the sheet transport path Rt in the width direction. That is, so-called center registration transport is performed through the sheet transport path Rt.

Letters W1 in FIG. 3 indicates the maximum width of the sheet 9 as the width W during discharge.

In addition, as shown in FIGS. 5 and 8, the wall surface portion 70 in Exemplary Embodiment 1 is provided such that a lower end 70u of the wall surface portion 70 is present at a position lower than the upper end of the side wall surface 622.

In Exemplary Embodiment 1, the upper end of the side wall surface 622 is the central upper end portion 622t.

Letters H1 in FIG. 8 indicate a position (height) of the lower end 70u of the wall surface portion 70. Letters H2 indicate a position (height) of the upper end (central upper end portion 622t) of the side wall surface 622.

The lower end 70u of the wall surface portion 70 is also a lower end 71u of the wall surface 71. In addition, the central upper end portion 622t of the side wall surface 622 is also a lower end (lower side) 61b of the discharge port 61.

The wall surface portion 70 in Exemplary Embodiment 1 is formed as follows in order to locate the lower end 70u thereof at a position lower than the upper end of the side wall surface 622.

That is, the wall surface portion 70 is formed in a state in which a lower portion 70c thereof protrudes downward from the lower surface portion 72b of the main body portion 72.

With this, the wall surface portion 70 has a depression 75 that protrudes upward and is surrounded by the lower portion 70c protruding downward, the lower surface portion 72b of the main body portion 72, and the moving body 671. The depression 75 is a space through which the wall surface portion 70 can pass without coming into contact with the central upper end portion 622t of the side wall surface 622 during the offset accommodation operation.

Further, as shown in FIG. 8, the wall surface portion 70 in Exemplary Embodiment 1 is provided such that an upper end 70t thereof is present inside the discharge roll 63.

In other words, the wall surface portion 70 is provided in a state in which the upper end 70t thereof does not protrude outward from the discharge roll 63.

The upper end 70t of the wall surface portion 70 is also serves as a horizontal upper surface 72t of the main body portion 72.

The upper end 70t of the wall surface portion 70 is present inside the side surface of the roll body 654 in the driven roll 65 that is disposed closer to the side wall surface 622 in the discharge roll 63.

### Recessed Portion

The recessed portion 80 is a recessed portion that is provided in the central upper end portion 622t which is the upper end of the side wall surface 622 of the accommodation portion 62.

In addition, the recessed portion 80 is a portion having a shape that is recessed downward such that the lower portion 70c of the wall surface portion 70 can pass through the recessed portion 80.

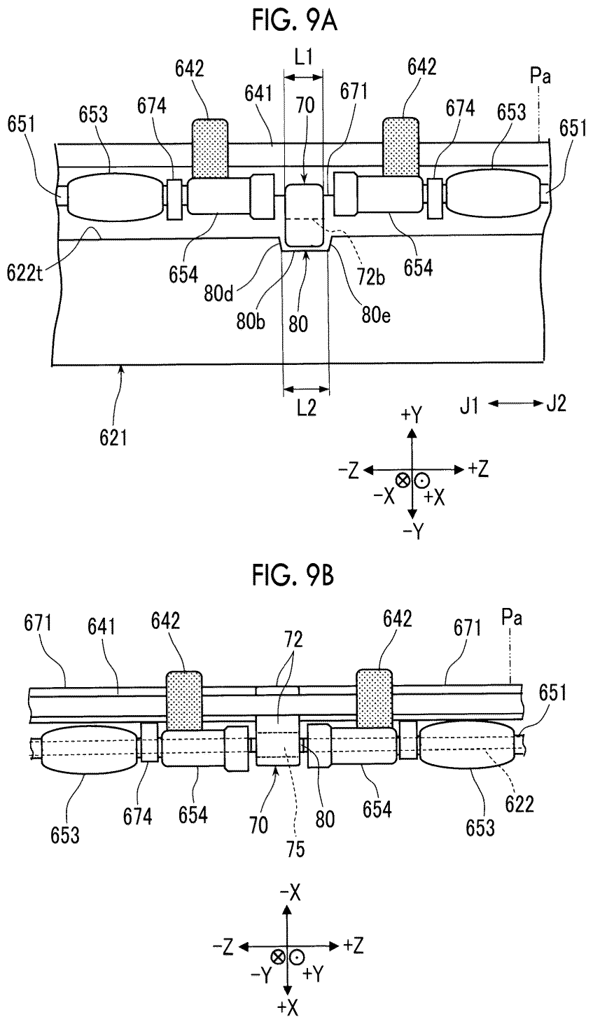

As shown in FIG. 9, the recessed portion 80 in Exemplary Embodiment 1 is formed in a shape having a bottom surface 80b and side end surfaces 80d and 80e on both sides.

The bottom surface 80b is a surface which is substantially parallel to the central upper end portion 622t at a position H3 that is a predetermined dimension d1 below the central upper end portion 622t of the side wall surface 622.

The predetermined dimension d1 is, for example, a dimension at which the bottom surface 80b does not come into contact with the lower end 70u of the wall surface portion 70 in a case where the side wall surface 622 is moved in the horizontal direction. Meanwhile, for example, a gap between the bottom surface 80b and the lower end 70u of the wall surface portion 70 is small. From this viewpoint, the gap is set to, for example, a dimension of 1 mm or less.

The side end surfaces 80d and 80e are surfaces that rise from both ends of the bottom surface 80b in the longitudinal direction to the central upper end portion 622t of the side wall surface 622.

Of the side end surface 80d and the side end surface 80e, the side end surface 80d is a downstream side end surface that is present on the downstream side in the first movement direction J1. In addition, the side end surface 80e is an upstream side end surface that is present on the upstream side in the first movement direction J1. The upstream side in the first movement direction J1 is the downstream side in the second movement direction J2.

In addition, as shown in FIGS. 9A and 9B and the like, the recessed portion 80 is provided at a position facing the wall surface portion 70 in a case where the moving unit 67 is stopped at the standby position Pa.

A width L2 (see FIGS. 9A and 9B) of the recessed portion 80 along the first movement direction J1 or the width direction E is set to a dimension that is slightly larger than a width L1 of the wall surface portion 70.

### Action and Effect of Wall Surface Portion

Then, in the sheet discharge and accommodation device 6, the sheet 9 discharged from the discharge port 61 is accommodated in the accommodation portion 62 in a state in which the surface on which the image has been formed faces downward (see FIGS. 1 and 10). The accommodation of the sheet having the image formed on one side in this state is sometimes referred to as, for example, face-down accommodation.

In addition, the sheet 9 on which the fixed image has been formed generally tends to be deformed to be curved and warped toward the side on which the image has been formed. The deformation to be warped to this state is referred to as so-called image curl.

For this reason, in the sheet discharge and accommodation device 6, for example, the accommodation surface 621 has a curved shape that is convex upward.

Therefore, even the sheet 9 with the image curl is accommodated well on the accommodation surface 621.

Meanwhile, the sheets 9 discharged from the discharge port 61 include a sheet 9X that is deformed to be curved and warped toward a side opposite to the side on which the image has been formed (see FIG. 10). The deformation to be warped to this state is referred to as so-called reverse image curl.

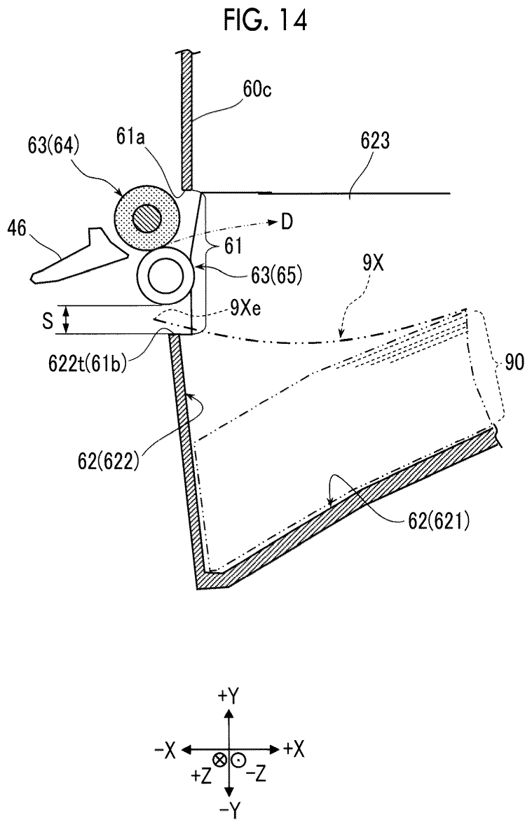

The sheet 9X with the reverse image curl may be moved such that a rear end on the downstream side in the discharge direction D enters a gap S (see FIG. 14) present between the discharge roll 63 and the side wall surface 622.

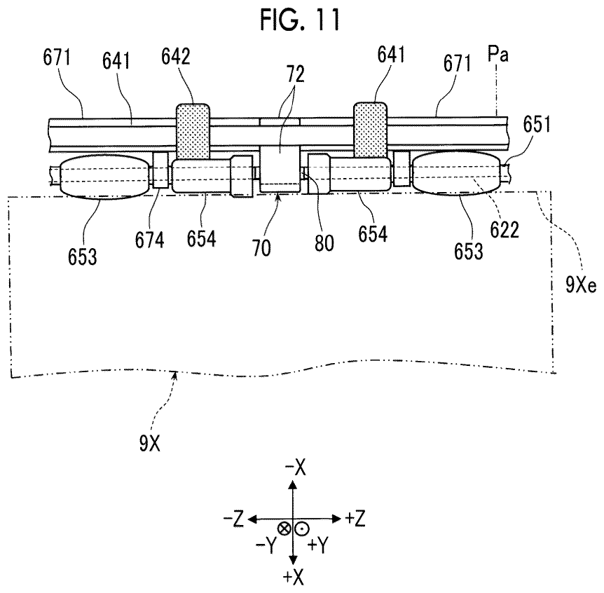

However, in the sheet discharge and accommodation device 6, as shown in FIGS. 10 and 11, even in a case where the rear end 9Xe of the sheet 9X in which the reverse image curl has occurred is moved to enter the gap S, the rear end 9Xe comes into contact with the wall surface portion 70 present in the gap S, and the entering of the rear end 9Xe is prevented.

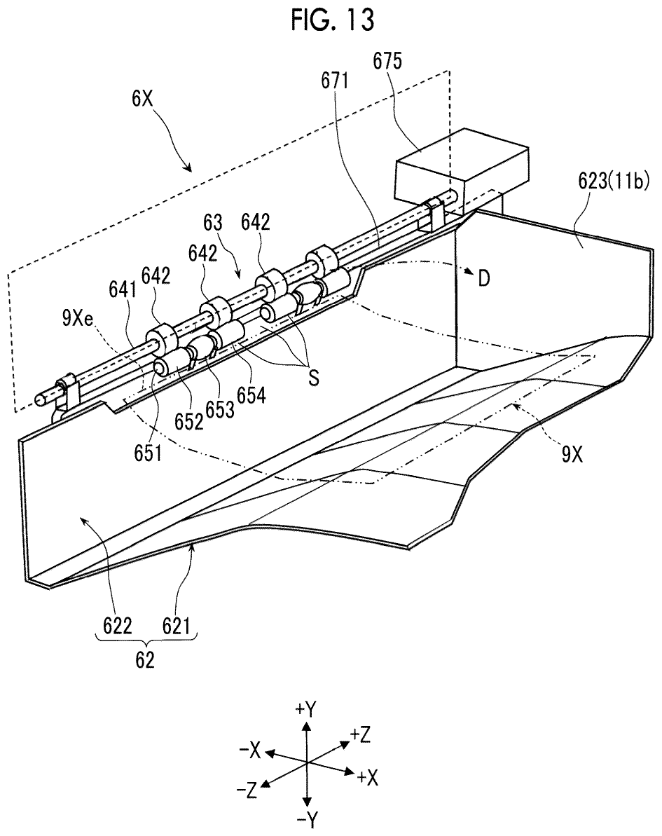

In contrast, as shown in FIGS. 13 and 14, a sheet discharge and accommodation device 6X according to a comparative example that does not include the wall surface portion (70) operates as follows.

That is, in the sheet discharge and accommodation device 6X according to the comparative example, the rear end 9Xe of the sheet 9X may enter the gap S present between the discharge roll 63 and the side wall surface 622 and may be stopped.

In addition, in an image forming apparatus including the sheet discharge and accommodation device 6X according to the comparative example, the sheet 9 is poorly accommodated in the accommodation portion 62 due to the entering of the rear end 9Xe of the sheet 9 into the accommodation portion 62.

Therefore, according to the sheet discharge and accommodation device 6, the rear end 9Xe of the sheet 9X discharged from the discharge port 61 to the accommodation surface 621 of the accommodation portion 62 by the discharge roll 63 that can reciprocate in the width direction E during the discharge of the sheet is prevented from entering the gap S.

In addition, in the image forming apparatus 10 including the sheet discharge and accommodation device 6, since the rear end 9Xe of the sheet 9X is prevented from entering the gap S, the occurrence of the poor accommodation of the sheet 9 in the accommodation portion 62 caused by the entering is avoided.

Further, in the sheet discharge and accommodation device 6, the wall surface portion 70 is provided in a gap present in the range, in which the sheet 9 with the minimum width W2 passes, among the gaps between adjacent roll bodies in the discharge roll 63.

Therefore, in the sheet discharge and accommodation device 6, even for the sheet 9 with the minimum width W2, the rear end 9e of the sheet 9 is prevented from entering the gap S.

In addition, in the sheet discharge and accommodation device 6, the wall surface portion 70 is provided such that the lower end 70u thereof is present at a position lower than the central upper end portion 622t which is the upper end of the side wall surface 622 of the accommodation portion 62.

Therefore, in the sheet discharge and accommodation device 6, the rear end 9e of the sheet 9 is less likely to enter the gap S as compared to a case where the lower end 70u of the wall surface portion 70 is present at the same position as the central upper end portion 622t of the side wall surface 622 or at a position higher than the central upper end portion 622t.

Further, in the sheet discharge and accommodation device 6, the wall surface portion 70 is provided such that the upper end 70t thereof is present inside the discharge roll 63.

Therefore, in the sheet discharge and accommodation device 6, the upper end 70t of the wall surface portion 70 may not obstruct the discharge path of the sheet 9 by the discharge roll 63, as compared to a case where the central upper end portion 622t of the side wall surface 622 protrudes to the outside of the discharge roll 63.

In addition, in the sheet discharge and accommodation device 6, the sheet 9 discharged from the discharge port 61 can also be accommodated in the accommodation portion 62 in a state in which the surface on which the image has been formed faces upward. The accommodation of the sheet having the image formed on one side in this state is referred to as, for example, face-up accommodation.

In this usage, in a case where the image curl occurs in the sheet accommodated in the face-up accommodation manner, the sheet 9 may be moved such that the rear end 9e enters the gap S.

However, in the sheet discharge and accommodation device 6, even in a case where the image curl occurs in the sheet 9 accommodated in the face-up accommodation manner, the wall surface portion 70 can prevent the rear end 9e of the sheet 9 from entering the gap S.

### Action and Effect of Wall Surface Portion

In addition, in a case where the side wall surface 622 of the accommodation portion 62 is assembled to the main body 60, the sheet discharge and accommodation device 6 including the wall surface portion 70 may be assembled incorrectly.

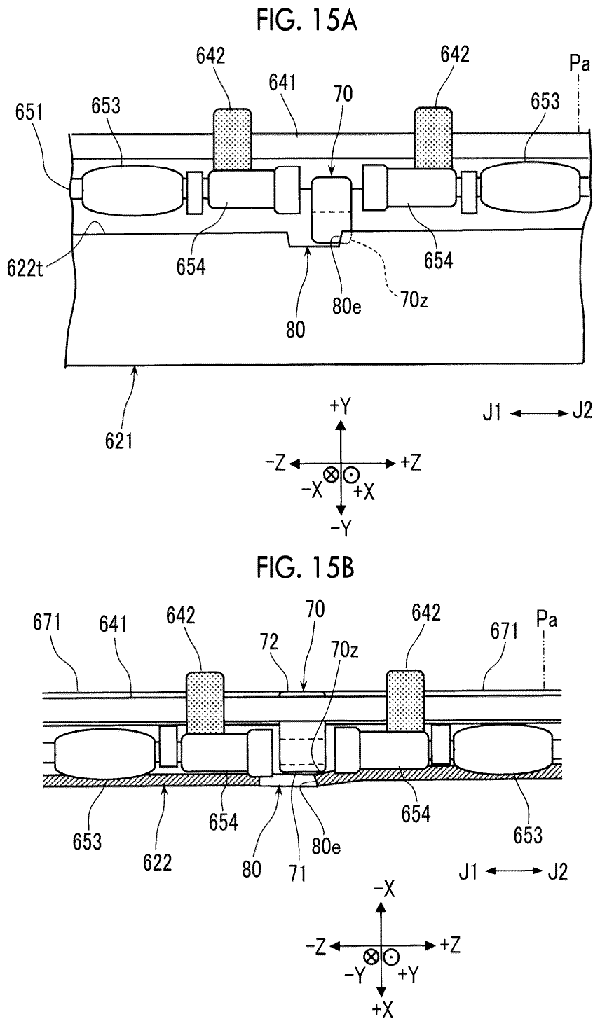

The incorrect assembly (wrong assembly) of the side wall surface 622 is assembly in a state in which the central upper end portion 622t, which is the upper end of the side wall surface 622, is stopped while riding on a portion 70z of the wall surface portion 70 as shown in FIGS. 15A and 15B.

The wrong assembly shown in FIGS. 15A and 15B is an example of assembly in a state in which a portion of a side end surface 80e on the upstream side of the recessed portion 80 in the side wall surface 622 rides on the portion 70z of the wall surface portion 70 and is stopped.

In addition, the wrong assembly may occur in a case where the moving body 671 of the moving unit 67 is not accurately stopped at the standby position Pa during the assembly work of the side wall surface 622 of the accommodation portion 62.

In addition, as represented by a two-dot chain line in FIG. 5, the wrong assembly is likely to occur in a case of an assembly structure in which a movement path Pw during the assembly work of the central upper end portion 622t of the side wall surface 622 may interfere with the wall surface portion 70.

However, in the sheet discharge and accommodation device 6, even in a case where wrong assembly occurs, the wrong assembly is automatically resolved by the movement of the moving body 671 of the moving unit 67 in the first movement direction J1 during an offset accommodation test run or a selection operation.

That is, in a case where the moving body 671 is moved in the first movement direction J1, the lower portion 70c of the wall surface portion 70 directly faces the recessed portion 80 in the side wall surface 622 and passes through the recessed portion 80.

During the passage, the portion 70z of the wall surface portion 70 passes through the recessed portion 80, is moved to the accommodation portion 62, and is present on the downstream side of the side wall surface 622 in the discharge direction D (see FIGS. 5 and 8).

In contrast, a sheet discharge and accommodation device which includes the wall surface portion 70, but does not have the recessed portion 80 provided in the side wall surface 622 operates as follows.

That is, in this sheet discharge and accommodation device, in a case where wrong assembly occurs, the wrong assembly is not resolved even though the moving body 671 of the moving unit 67 is moved in the first movement direction J1.

That is, in this case, there is no opportunity for the wall surface portion 70 to be moved and present on the downstream side of the side wall surface 622 in the discharge direction D.

In addition, in this sheet discharge and accommodation device, the moving body 671 of the moving unit 67 is forcibly moved in a state in which the wall surface portion 70 is in contact with the side wall surface 622. Therefore, the movement drive device 675 of the moving unit 67 or the like may be damaged.

Therefore, in the sheet discharge and accommodation device 6, even in a case where wrong assembly occurs in the side wall surface 622 of the accommodation portion 62, the wrong assembly state is automatically resolved by the passage of the recessed portion 80 during the movement of the moving unit 67.

In addition, in the sheet discharge and accommodation device 6, the recessed portion 80 is provided at the position facing the wall surface portion 70 in a case where the moving unit 67 is stopped at the standby position Pa.

Therefore, according to the sheet discharge and accommodation device 6, the side wall surface 622 of the accommodation portion 62 can be assembled easily and normally without unnecessary collision with the wall surface portion 70, as compared to a case where the recessed portion 80 is not provided at the position facing the wall surface portion 70 in a case where the moving unit 67 is not present at the standby position Pa.

### Modification Examples

The present invention is not limited to the configuration examples described in each of the above-described exemplary embodiments. The present invention can be modified as necessary without departing from the gist of the invention described as means for addressing the problems.

Therefore, the present invention also includes, for example, the following modification examples.

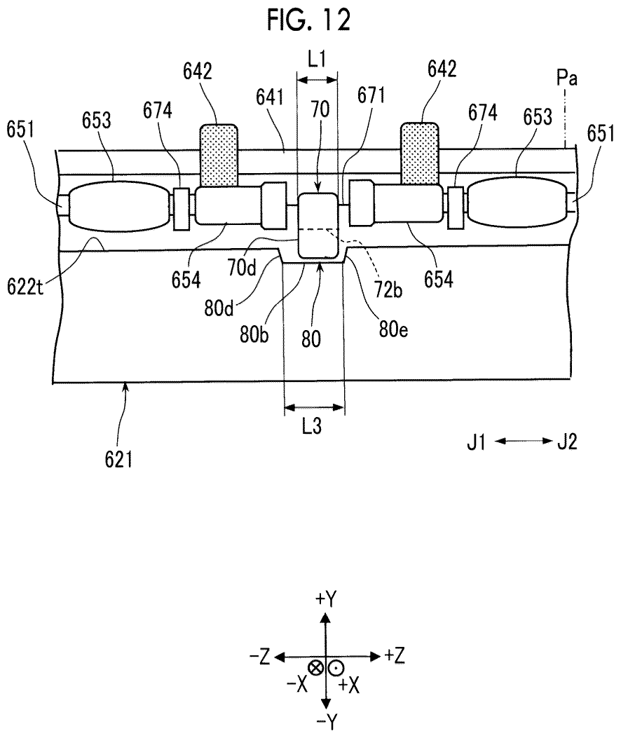

As shown in FIG. 12, the recessed portion 80 may be provided such that a side end surface 80d on the downstream side in the first movement direction J1 is located at a position that is shifted from an end portion 70d on the downstream side of the wall surface portion 70 at the standby position Pa to the movement destination position Pb of the moving unit 67.

A width L3 of the recessed portion 80 shown in FIG. 12 is larger than the width L2 of the recessed portion 80 in Exemplary Embodiment 1 by the amount of shift of the side end surface 80d on the downstream side.

In a case where the recessed portion 80 according to this modification example is adopted, even though the wrong assembly occurs, the wrong assembly state is easily resolved during the movement of the moving unit 67, as compared to a case where the side end surface 80d on the downstream side of the recessed portion 80 is not formed at the position shifted to the movement destination position Pb.

A plurality of wall surface portions 70 may be provided in the moving body 671 of the moving unit 67.

In addition, the wall surface portion 70 may be provided such that the lower end 70u is at substantially the same height as the central upper end portion 622t of the side wall surface 622 of the accommodation portion 62. In a case where the wall surface portion 70 according to this modification example is provided, the provision of the recessed portion 80 in the central upper end portion 622t of the recessed portion 80 may be omitted.

The sheet discharge and accommodation device 6 may include the accommodation portion 62 that protrudes from one side wall surface of the housing 11 of the image forming apparatus 10.

In the case of the sheet discharge and accommodation device 6 according to this modification example, the side wall surface 622 of the accommodation portion 62 may also serve as the one side wall surface of the housing 11.

For the image forming apparatus including the sheet discharge and accommodation device 6, an image forming method of the image forming apparatus, the type of image to be formed by the image forming apparatus, and the like are not particularly limited.

Therefore, for the image forming apparatus, the image forming device 20 may be an image forming device that adopts an image forming method, such as an inkjet method or a printing method, instead of the electrophotographic method.

The image forming apparatus is not limited to an apparatus that forms a multi-color image and may be an apparatus that forms a monochrome image.

### Supplementary Notes

(((1)))

A sheet discharge and accommodation device comprising:
a main body having a discharge port;
an accommodation portion having an accommodation surface on which a sheet discharged from the discharge port is accommodated and a side wall surface that extends from one end of the accommodation surface to a lower end of the discharge port;
a discharge roll that pinches the sheet between a plurality of roll bodies disposed on a plurality of shafts and discharges the sheet from the discharge port to the accommodation portion;
a moving unit that is provided with the discharge roll and reciprocates in a width direction intersecting a discharge direction of the sheet; and
a wall surface portion that is provided in the moving unit, is present at least in a space from an upper end of the side wall surface to a shaft that is closer to the upper end among the plurality of shafts, and is present on a downstream side of the side wall surface in the discharge direction.
   (((2)))

The sheet discharge and accommodation device according to (((1))), wherein the wall surface portion is disposed in a gap present in a range, in which a sheet with a minimum width during discharge passes, among gaps between adjacent roll bodies among the plurality of roll bodies.

(((3)))

The sheet discharge and accommodation device according to (((1))) or (((2))), wherein a lower end of the wall surface portion is present at a position lower than the upper end of the side wall surface.

(((4)))

The sheet discharge and accommodation device according to any one of (((1))) to (((3))), wherein an upper end of the wall surface portion is present inside the discharge roll.

(((5)))

The sheet discharge and accommodation device according to any one of (((1))) to (((4))), wherein a recessed portion through which a lower portion of the wall surface portion is capable of passing is provided at the upper end of the side wall surface.

(((6)))

The sheet discharge and accommodation device according to (((5))), wherein the recessed portion is provided at a position facing the wall surface portion in a case where the moving unit is stopped at a standby position.

(((7)))

The sheet discharge and accommodation device according to (((6))), wherein the recessed portion is provided such that a side end surface of the recessed portion on a downstream side in a first movement direction in a case where the moving unit is moved from the standby position to a movement destination position in a width in the width direction is disposed at a position shifted to the movement destination position.

(((8)))

An image forming apparatus comprising:
the sheet discharge and accommodation device according to any one of (((1))) to (((7))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A sheet discharge and accommodation device comprising:
a main body having a discharge port;
an accommodation portion having an accommodation surface on which a sheet discharged from the discharge port is accommodated and a side wall surface that extends from one end of the accommodation surface to a lower end of the discharge port;
a discharge roll that pinches the sheet between a plurality of roll bodies disposed on a plurality of shafts and discharges the sheet from the discharge port to the accommodation portion;
a moving unit that is provided with the discharge roll and reciprocates in a width direction intersecting a discharge direction of the sheet; and
a wall surface portion that is provided in the moving unit, is present at least in a space from an upper end of the side wall surface to a shaft that is closer to the upper end among the plurality of shafts, and is present on a downstream side of the side wall surface in the discharge direction.

2. The sheet discharge and accommodation device according to claim 1,
wherein the wall surface portion is disposed in a gap present in a range, in which a sheet with a minimum width during discharge passes, among gaps between adjacent roll bodies among the plurality of roll bodies.

3. The sheet discharge and accommodation device according to claim 2,
wherein a lower end of the wall surface portion is present at a position lower than the upper end of the side wall surface.

4. The sheet discharge and accommodation device according to claim 3,
wherein an upper end of the wall surface portion is present inside the discharge roll.

5. The sheet discharge and accommodation device according to claim 1,
wherein a recessed portion through which a lower portion of the wall surface portion is capable of passing is provided at the upper end of the side wall surface.

6. The sheet discharge and accommodation device according to claim 5,
wherein the recessed portion is provided at a position facing the wall surface portion in a case where the moving unit is stopped at a standby position.

7. The sheet discharge and accommodation device according to claim 6,
wherein the recessed portion is provided such that a side end surface of the recessed portion on a downstream side in a first movement direction in a case where the moving unit is moved from the standby position to a movement destination position in a width in the width direction is disposed at a position shifted to the movement destination position.

8. An image forming apparatus comprising:
the sheet discharge and accommodation device according to claim 1.

9. An image forming apparatus comprising:
the sheet discharge and accommodation device according to claim 2.

10. An image forming apparatus comprising:
the sheet discharge and accommodation device according to claim 3.

11. An image forming apparatus comprising:
the sheet discharge and accommodation device according to claim 4.

12. An image forming apparatus comprising:
the sheet discharge and accommodation device according to claim 5.

13. An image forming apparatus comprising:
the sheet discharge and accommodation device according to claim 6.

14. An image forming apparatus comprising:
the sheet discharge and accommodation device according to claim 7.
